(19) United States
(12) Patent Application Publication
(10) Pub. No.: US 2003/0201059 A1
(43) Pub. Date: Oct. 30, 2003

(54) Selective manipulation of material for medical devices and methods and devices made therefrom

(76) Inventors: Thomas J. Holman, Minneapolis, MN (US); Daniel J. Horn, Shoreview, MN (US); Lixiao Wang, Long Lake, MN (US); Brian J. Hanson, Shoreview, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/131,798

(22) Filed: Apr. 24, 2002

(51) Int. Cl. B32B 31/28; B29C 65/14; B29C 65/16

(52) U.S. Cl. 156/155; 156/272.2

(57) ABSTRACT

A method for manipulating a portion of a medical device comprises the following steps. Provide a medical device having components which are adjacent to each other. a first portion of a component constructed and arranged to at least partially absorb a predetermined wavelength of energy. A second portion of a component being substantially transparent to the predetermined wavelength of energy. Transmit the predetermined wavelength of energy through the second portion and expose the first portion to the energy. The first portion being heated as a result of substantially absorbing the energy. Transmit heat from the first portion to at least one adjacent portion of the components. Melt the first portion and the at least one adjacent portion. Removing the energy from the first portion. A bond being formed between the first portion and the second portion by allowing the portions to cool together.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

Manipulation of materials by application of energy, such as by heating is a well known and well understood practice. Materials, such as polymer based materials, may be manipulated through the application of heat which is sufficient to raise the temperature of the material to a point where the hardness of the material begins to decrease allowing the material to be more readily shaped or molded. Further application of heat may cause portions of the material to melt, thereby allowing the melted portions of the material to be separated from adjacent materials and/or be bonded to other materials as they cool. Where portions of adjacent materials are both allowed to melt, the melted regions may subsequently be allowed to cool together, resulting in the materials being fused. If the heat applied to the material is sufficient, the material may attain a liquid state allowing the material to have a readily directed flowability. Still further application of even greater heat to the material may result in ablation of portions of the material as the material attains a temperature sufficient to vaporize portions thereof.

Many different methods exist for heating a material so that the material may be manipulated in a desired manner. For example the material may be directly heated by a heating element. However, if the material which is sought to be heated and manipulated is surrounded by other materials or is difficult to access directly, direct application of heat becomes problematic if not impossible.

Materials may be manipulated through the application of a variety of forms of energy. Energy, in its various forms and mediums may be transmitted to a material or materials. Transmittible energy may be photons, electrons or other energy characteristic having a wavelength absorbable by the material or materials. Such transmittible and absorbable forms of energy are hereinafter collectively referred to as energy or photons.

As indicated above one form of material manipulation is by heating the material. In many cases, laser energy is transmitted to the materials. Laser photons may be employed to heat, shape, ablate, and to otherwise manipulate materials, even when such materials are difficult to access or underlie other layers of materials. Laser application procedures, such as laser transmission welding (LTW) provides for laser light to be transmitted largely unabsorbed through one layer of material and absorbed by a second material which is more optically dense, in that frequency or wavelength, than the first material. As a result of the energy absorbing qualities of the second material, the second material is heated. Contact between the first and second material ensures that the first material is also heated thereby allowing fusion of the materials when the second material is sufficiently heated to melt the materials.

Key features for ensuring proper absorption and/or transmission of energy in a given material are the wavelength of the photons transmitted to the material(s) and the particular wavelength absorption characteristics of the material(s). For example, a material which absorbs wavelengths of 10.6 μm will absorb, and thus be heated by, the laser energy emitted by a CO₂ laser which typically has a wavelength of operation of about 10.6 μm. Whereas a material which allows energy having a wavelength of 10.6 μm to pass therethrough will not significantly absorb such energy. Many medical devices, such as catheters and other implantable devices, are often quite small and may include several layers of material. In the construction of many catheters, inner layers of material must first be applied and manipulated as desired before subsequent outer layers are added to the device. The ease of constructing many types of many medical devices, particularly catheters, would be substantially improved if portions of material, or layers of material, positioned within the catheter housing could be selectively bonded, welded, heated, separated, shaped or otherwise manipulated at any time during or following catheter construction, regardless of the position or number of layers comprising the device.

By providing a medical device with materials having particular wavelength absorption characteristics and/or particular thermal sublimation characteristics, one or more portions of the device, even those normally inaccessible to more common mechanical manipulation, may be readily manipulated through the use of appropriate wavelengths of energy.

The entire content of all patents listed within the present patent application are incorporated herein by reference.

### BRIEF SUMMARY OF THE INVENTION

This invention includes several different embodiments. Some embodiments of the invention relate to methods of manufacturing or modifying medical devices by selectively manipulating one or more materials of the medical device by applying particular forms of energy, such as for example particular wavelengths of photons, such as by application of laser light, to selected areas of the material(s) to be manipulated. Medical devices that may include materials that may be selectively manipulated in such a manner include, but are not limited to: catheters and catheter components such as housings, shafts, sheathes, sleeves, socks, guide wires, balloons; stents, grafts, stent-grafts, and vena cava filters; biopsy forceps, intravascular ultrasound (IVUS), septal defect repair devices; pace makers components, such as pace maker leads; etc.

Energy sensitive material(s), or one or more portions thereof, may include, or be treated to include, unique properties that enable the material(s) to absorb, reflect, scatter or otherwise be affected by particular wavelengths of photons that may be applied thereto.

In some embodiments of the invention, a medical device such as a catheter may have multiple layers of various materials. One or more layers of material may inherently have, or may be provided with, particular energy sensitive properties. For example, one or more of the layers of a catheter may have properties which allow the material to absorb light energy of a particular wavelength, whereas other material may freely transmit energy of the same wavelength. As a result, those portions which absorb a particular wavelength may be heated when light energy having the required wavelength is applied to the material, while other material may remain unaffected.

“Selective manipulation” of a material as used herein refers to manipulating the interaction of energy supplied by an energy source, such as a laser, and a material or materials. For example, in at least one embodiment, a material having a particular energy absorbing quality (i.e. an energy absorbing material) may be applied to, or utilized with a material that may not be particularly absorbent of the particular type of energy which the energy absorbing material is configured to absorb (i.e. a non-energy absorbing material). The energy absorbing material may be heated to a predetermined extent up to and even in excess of the material's melting point by application of a desired form of energy. Conduction of heat from the energy absorbing material to the non-energy absorbing material will allow the energy absorbing material as well as any non-energy absorbing materials to be selectively manipulated as a result of the interactions between the energy transmitted to the energy absorbing material, and the heat transmitted from the energy absorbing material and the non-energy absorbing material(s).

By selective manipulation of energy and material, materials that are considered to be “non-energy” absorbing materials may be fused or otherwise affected. By this method material or materials may be, separated, manipulated to a desired shape, vaporized, ablated or be otherwise affected by heating selective portions thereof. The energy absorbing material may itself be altered, sublimated and/or vaporized after it has absorbed enough energy to be heated to a critical temperature. By utilizing a material that sublimates and/or vaporizes at a critical temperature, the depth and temperature that the catheter may be affected can be controlled.

A material may be provided with such energy absorbing properties by coating a layer or portion of a medical device with a particular pigment, dye or other colorant. Alternatively, such pigment, dye or colorant may be included in the material's composition. Other means of providing a material with energy sensitive properties includes providing the material's composition with absorber compounds, such as black, green, red or other colors of pigments or colorants, and/or materials such as silicone oxide, to convert light energy to heat. Other types of coatings or additives include but are not limited to: metal films, metallic particles, powder coatings of various materials, various coatings of energy absorbent or reflective material, etc.

In some medical devices energy sensitive materials may be positioned underneath or within intervening materials, wherein the intervening materials may have different energy sensitive properties or which may be effectively transparent to the particular form of energy that affects the energy sensitive materials. As a result, devices, such as catheters, having such energy sensitive materials in their construction and having portions which are difficult or impossible to mechanically access, may be readily manipulated by applying the proper form of energy to which only the energy sensitive materials are affected, thereby manipulating the energy sensitive materials without affecting adjacent materials having different energy sensitive properties.

In some embodiments of the invention, a medical device may be provided with one or more energy absorbing material(s) having energy absorbing characteristics which are different from other energy absorbing material(s). A particular energy absorbing material may be configured to absorb none, or a limited amount of, one or more forms of energy and to absorb significant quantities of yet one or more other forms of energy. As a result, various energy absorbing materials may be manipulated to the same or different extent by application of one or more types of energy. In at least one embodiment for example, at least two different energy sources, such as may provided by two different types of laser light, may be used to affect material or materials that have been treated with at least two different dyes or colorants.

To a similar extent, various embodiments of the invention may utilize different forms of energy to affect a particular material differently. For example, a first form of laser light of a particular first wavelength may pass freely through a particular material. When the light is transmitted at a second wavelength through the same material, the light may be absorbed in-whole or in-part by the material. When the light is transmitted at a third wavelength toward the same material, it may be possible that the material will reflect the light. These features allow one or more materials and/or locations of a device to be manipulated through selective application of energy as may be desired.

Further aspects of the invention will become apparent from the detailed description which follows.

### BRIEF DESCRIPTION OF THE SEVERAL VIEWS OF THE DRAWINGS

A detailed description of the invention is hereafter described with specific reference being made to the drawings.

FIG. 1 is a side view of an embodiment of the invention.

FIG. 2 is a side view of an embodiment of the invention.

FIG. 3 is a side view of an embodiment of the invention. FIG. 4 is a side view of an embodiment of the invention.

FIGS. 5 and 6 illustrate an embodiment of the invention wherein a polymer shaft is shown being bonded to a distal tip.

FIG. 7 is a side view of an embodiment of the invention.

FIG. 8 is a side view of an embodiment of the invention.

FIG. 9 is a side view of an embodiment of the invention.

FIG. 10 is a side view of an embodiment of the invention.

FIG. 11 is a side view of an embodiment of the invention.

FIG. 12 is a side view of an embodiment of the invention.

FIG. 13 is a side view of an embodiment of the invention.

FIG. 14 is a side view of an embodiment of the invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

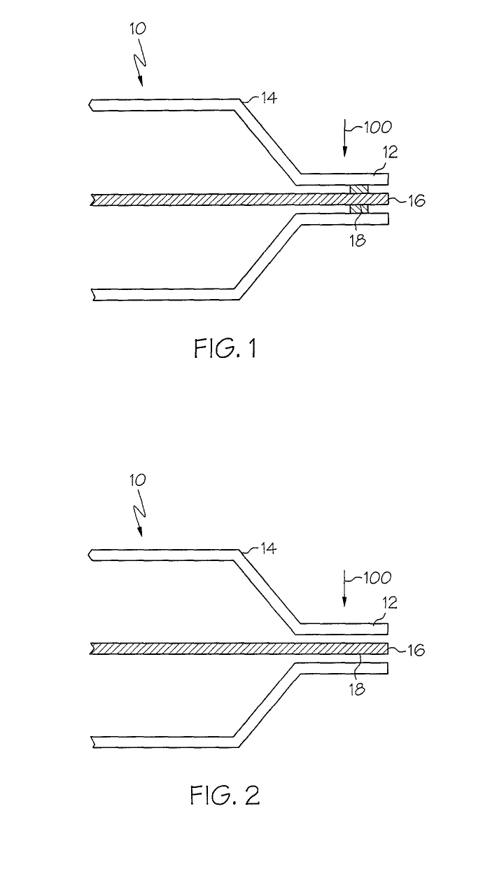

In FIG. 1 a portion of a medical device such as a catheter 10 is shown wherein an end 12 of a tubular member such as a balloon 14 is shown prior to being bonded to a portion of an inner member or shaft 16 of the catheter 10. A material 18 may be configured to absorb a predetermined wavelength or frequency of energy, represented by arrow 100. For example, laser light of a particular wavelength may be utilized to affect the various components of the catheter 10. Depending on the type of laser used, the particular energy absorbing properties of the materials and time energy is applied to the materials, the various components of the catheter 10 may be selectively manipulated to various extent. For example, a particular type of YAG laser will transmit laser energy having a wavelength of about 1054 nanometers. A particular type of diode laser transmits laser light within a range of about 650 nanometers to about 950 nanometers, and a particular type of carbon dioxide laser will transmit light at about 10,600 nanometers. The various components of the catheter 10 that are desired to be manipulated may be, to various extent, specifically configured to be absorbent of such 110 wavelengths of energy or be specifically configured not to interact with such wavelengths. Thereby allowing the components to be affected to greater or lesser extent by a particular energy form.

Any material discussed herein which is characterized as having energy absorbing characteristics or which is configured to absorb a predetermined wavelength of energy, such as material 18, may be made to absorb a predetermined wavelength of energy in a variety of ways. Alternatively, materials, such as material 18, may be made to reflect, scatter, or pass various wavelengths of energy.

For example, in the embodiments shown, a catheter 10, may have various components such as shaft 16, balloon end 12, etc. Any or all of these components, or portions thereof, may be configured as or provided with material 18. The various components of the catheter 10, particularly material 18, are preferably constructed from one or more thermoplastic materials. In some embodiments the components may be molded polymers, thermoplastic polymers, thermoplastic elastomers, polymers films, etc. In at least one embodiment one or more of the components of catheter 10 is constructed from or includes a polyolefin film or layer. Other potentially useful materials include: polypropylene, polyethylene, various co-polymers and blends of polyethylene ionomers, polyesters, urethane, polyurethanes, polycarbonates, polyamides, poly-vinyl chloride, acrylonitrile-butadiene-styrene copolymers, polyether-polyester copolymers, low density polyethylene (LDPE), high density polyethylene (HDPE), ethylene vinyl acetate (EVA), nylon, and polyetherpolyamide copolymers. Other suitable materials include a copolymer polyolefin material available from E. I. DuPont de Nemours and Co. (Wilmington, Del.), under the trade name SURLYN™ Ionomer and a polyether block amide available under the trade name PEBAX™. Some other materials include relatively non-compliant materials such as rigid of stiff high pressure polymeric materials, such as thermoset polymeric materials, poly(ethylene terephthalate) (commonly referred to as PET), polyimide, thermoplastic polyimide, polyesters, polycarbonates, polyphenylene sulfides, polypropylene and rigid polyurethanes.

One way of providing a material with a desired characteristic, particularly an absorption characteristic, is to provide the material with a particular colorant such as a dye or pigment. The colorant may be included in the composition of the material or may be a coating placed thereon. Alternatively, a material may be made to absorb a particular wavelength of energy by providing the material with absorber compounds, such as silicone oxide (glass), to convert light energy to heat. Other types of additives or coatings include but are not limited to: metal films, powder coatings of various materials, and other substances such as fiber glass may also be utilized.

In the embodiment shown in FIG. 1 the material 18 is positioned between the balloon end 12 and the inner shaft 16. In some embodiments, the material 18 may comprise thermoplastic polymer that is configured to absorb a particular wavelength of energy by having a colorant such as graphite (black), copper oxide (green), titanium dioxide (white) and/or other colorants as well. Some examples of commercially available colorants are the Kesorb line of colorants available from Keystone Aniline Corporation of Chicago, Ill.; the various near infrared dyes available form American Dye Source, Inc. of Quebec, Canada; Filtron® dyes from Gentex Corporation of Zeeland, Mich.; among others.

Some examples of dyes suitable for use in the present invention include cyanine dye, squarylium dye, and croconium dye. Dyes and other colorants may be added to the bulk of a polymer during the manufacturing process of the catheter 10 and its components. Alternatively, dyes and colorants may be incorporated into a thin film which functions as material 18. For example, a catheter 10 having components such as end 12 and shaft 16 constructed from polymethylmethacrylate (PMMA) may have one or more layers of material 18 positioned at their interface. Material 18 may be methylmethacrylate (MMA) containing a near infrared absorber dye.

It must be noted that some materials may inherently absorb a particular wavelength of energy and would thus not require an additive colorant or a supplemental layer of material 18 such as those previously described.

In various embodiments material 18 is preferably a colored polyamide material or materials such as have been described by Dr. V. Kagan et al. In the paper entitled Infra-Red Welding Technology and Developed Materials for a New Era as presented at Polyamide 2001 in Düsseldorf Germany Jun. 11-13, 2001.

The material 18 which is inherently energy absorbent or which has been made to be energy absorbent, may be configured to at least partially absorb one or more predetermined wavelengths of energy. For example, material 18 may be an IR, UV, microwave, laser light, or other form of energy absorber. Preferably, the material 18 is configured to at least partially absorb one or more wavelengths of laser light such as may be supplied by one or more lasers, such as a YAG laser, diode laser, and/or carbon dioxide laser.

In some embodiments a predetermined wavelength of energy 100 may be supplied by an infra-red laser such as those commercially available from various manufacturers, including but not limited to: Dart™ from Convergent Energy, Laser-Tec from Bielomatik, IRAM sold by Branson, DL from Fraunhofer/Rofin Sinar, Modulas available from Leister, Impact from Limonics, Focus One sold by Sonotronic, SK-90 by TampoPrint, LW15 from Unitek Miyachi among others.

In the embodiment shown, the balloon 14 or a portion thereof, such as the end 12, is substantially clear to the particular wavelength of energy which the energy absorbing material is intended to absorb.

When the predetermined wavelength of energy 100 is applied to the end 12 and is transmitted through the end 12 and is at least partially absorbed by the energy absorbing material 18, the energy absorbed by the material 18 may be transformed into heat. As the energy absorbing material is heated, heat will be conductively transmitted to surrounding components of the catheter including end 12 and shaft 16. Depending on the composition of the various components, the material 18, end 12, and/or shaft 16 may be heated to a point where the surfaces of one or more of the components begin to melt. When the energy is no longer transmitted to the material 18 adjacent components that had begun to melt will resolidify together as they cool in a manner similar to direct heat welding.

In an example of the embodiment shown in FIG. 1, a 3.0 mm diameter balloon having an end 12 was constructed from PET (Traytuff 7357). Material 18 was constructed of 1.5% Plexar 1164 as tie material, 0.5% ADS 1065A (black NIR absorption dye from American Dye Source) dissolved in Toluene solvent, was painted onto inner shaft 16, which was constructed of HDPE. A diode laser was utilized to transmit laser energy at 810 nanometer to the bond location. Materials 12 and 16 are both “non-absorbing” to this wavelength of energy while material 18 is absorbent thereof. After selective manipulation of the materials was completed, in this example laser welding the bond site, the resultant mounted balloon was burst tested and found to burst at 375 psi with a longitudinal burst thru the body of the balloon indicating acceptable heating at the bond site. In an alternative example, Keysorb 810NM #993-980-50 (from Keystone of Chicago, Ill.) is used as the absorbing material.

In an alternative embodiment shown in FIG. 2, the end 12 may be directly bonded to the shaft 16. In this embodiment, the end 12 is clear to the predetermined wavelength of energy and the shaft 16 contains or is comprised of energy absorbent material 18 which is energy opaque or is constructed to at least partially absorb the predetermined wavelength of energy 100. As a result, when the predetermined wavelength of energy 100 is transmitted through the end 12, the material 18 of shaft 16 will be heated. A bond is formed when one or both of end 12 and/or shaft 16 begin to melt and are then allowed to cool together.

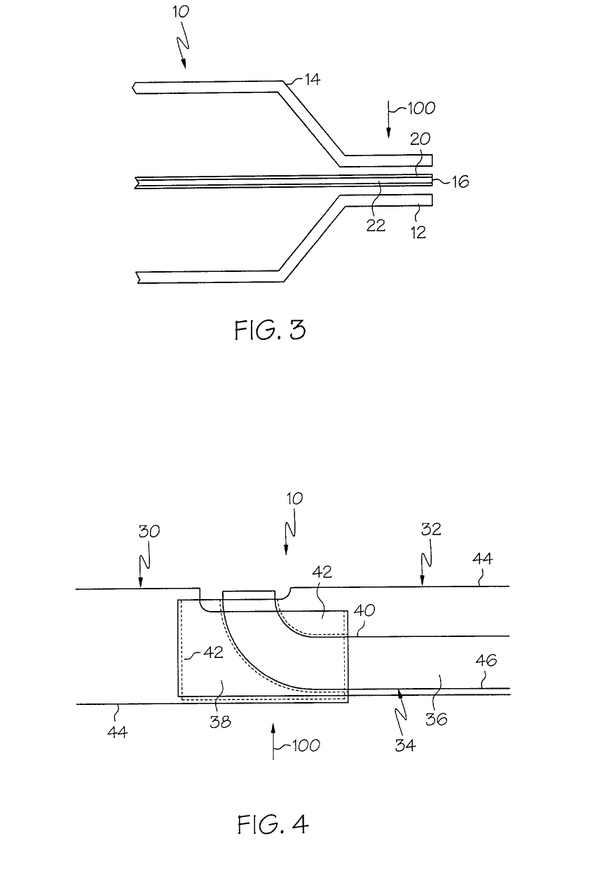

In another embodiment shown in FIG. 3, the end 12 may be bonded to a multi-layer shaft 16. In this embodiment, the outer layer 20 of the shaft 16 is opaque or absorbent to the predetermined wavelength of energy 100, whereas the inner layer 22 is energy transparent as is end 12. As a result, when the predetermined wavelength of energy 100 is applied to end 12 and transmitted therethrough, the outer layer 20 of the shaft 16 will at least partially absorb the energy. As energy is absorbed by the outer layer 20, the layer 20 will be heated and may thus be bonded to the end 12, in the manner previously discussed.

In another embodiment of the invention shown in FIG. 4 a midshaft seal of a catheter 10 is shown wherein a midshaft housing 30 is bonded to the distal outer housing 32 an inner shaft 34 defines a lumen 36 which extends distally from the seal 38.

The seal 38 may be formed by providing the exterior 40 of the inner shaft 34 and the interior surface 42 of both the midshaft housing 30 and the distal outer housing 32 with energy absorbing properties such as previously described. The exterior 44 of the housings 30 and 32 are substantially energy transparent as is the interior 46 of the inner shaft 34. As a result when the predetermined wavelength of energy 100 is applied to the catheter 10, energy will pass through the exterior 44 of the housings 30 and 32 and be absorbed by the interior 42 of the housings 30 and 32 as well as the exterior 40 of the inner shaft 34. As a result, the exterior 40 and interior 42 may be heated to melting and then allowed to cool together thereby forming seal 38.

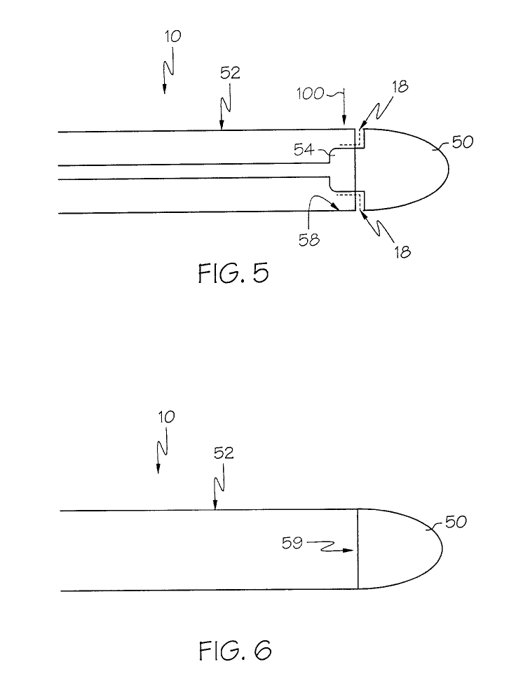

In yet another embodiment of the invention shown in FIG. 5 a distal tip 50 is shown prior to being bonded to a polymer shaft 52 of a catheter 10. In some embodiments the distal tip 50 may be a sensor head comprising a camera or other sensory device. The polymer shaft 52 may be bonded to an engagement portion 54 of the tip 50 by providing an energy absorbing material, such as material 18, on the engagement portion 54. Preferably, the energy absorbent material 18 is an inherent part of the engagement portion 54 and/or the interior 58 of the polymer shaft 52. In some embodiments the engagement portion 54 and shaft 52 are constructed of materials which will melt at or around the same temperature as the material 18.

In the embodiment shown, the predetermined wavelength of energy 100 is transmitted through shaft 52 and is absorbed by material 18. Material 18 is then heated causing the surrounding portions of the shaft 52 and engagement portion 54 to be heated to melting. The shaft 52 and engagement portion 54 are subsequently allowed to cool together to form a seal 59 such is shown in FIG. 6.

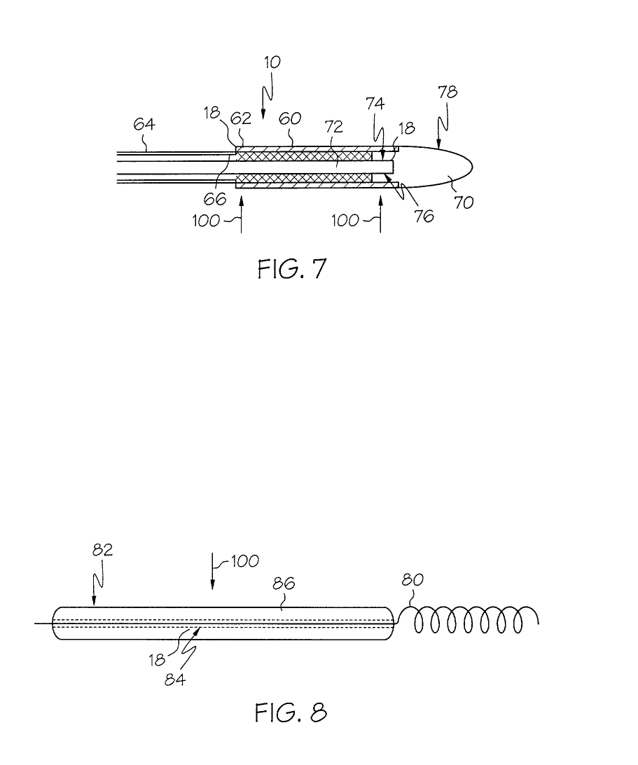

In FIG. 7 a catheter 10 is shown which illustrates a variety of different places for which the use of energy absorbent material could be utilized to provide bonds between catheter components. The catheter shown includes a pull back sheath 60, the proximal end 62 of the sheath 60 is engaged to a pull back device 64. The distal end 66 of the pull back device 64 may be coated with an energy absorbing material 18, or such energy absorbent qualities may be a feature of the distal end 66 and/or the proximal end 62 of the sheath 60. Application of the predetermined wavelength of energy 100 thereto will readily form a bond between the sheath 60 to the pull back device 64.

In FIG. 7 the catheter 10 is also shown equipped with a distal tip 70 which is engaged to an inner member or shaft 72. The outer surface 74 of the member 72 may possess energy absorbent qualities or include energy absorbent material 18. In addition or alternatively, the engagement surface 76 of the tip 70 may also include energy absorbent qualities. The predetermined wavelength of energy 100 may be transmitted through the sheath 60 and outer surface 78 of the tip 70 to heat and bond the member 72 to the engagement surface 76 of the tip 70.

In yet another embodiment of the present invention, a guide wire 80 is shown having a polymer sheath 82. The guide wire may have a coating of energy absorbing material 18, and/or the interior 84 of the sheath 82 may have energy absorbing properties. The predetermined wavelength of energy 100 may be transmitted through the outer portion 86 of the sheath 82 to heat and potentially melt the material 18 and/or the interior 84, thereby bonding the interior 84 of the sheath 82 to the guide wire 80.

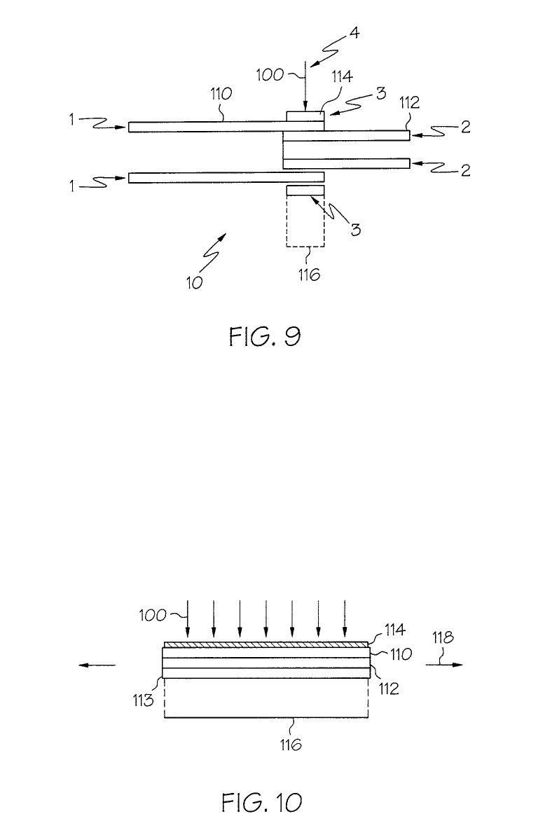

In at least one embodiment, such as is shown in FIG. 9, a catheter 10 may have components or layers 110 and 112 that are characterized as being non-absorbent of a particular type of energy 100. A third layer 114 of material maybe disposed about a welding region 116. The third layer 114 is preferably a dye or dye polymer matrix that is constructed and arranged to absorb energy 100. The third layer 114, is further constructed and arranged to sublimate and/or vaporize at a temperature greater than that of the melting temperature of the first layer 110.

To bond a portion of the layers 110 and 112 together at the welding region 116, energy 100 is transmitted to the third layer 114. The energy 100 is absorbed by the third layer 114 which is heated as a result. The heat is transmitted to the first layer 110 by conduction. After a predetermined amount of time, conduction of heat from the third layer 114 to the first layer 110 is sufficient to cause the first layer 110 to melt into the second layer 112. As the first layer 110 is melting, energy 100 continues to heat the third layer 114 causing the third layer 114 to sublimate and/or vaporize

The energy 100 and third layer 114 are controlled such that when the desired amount of the first layer 110 has melted onto the second layer 112, the third layer will be completely vaporized and/or sublimated, thereby ceasing the heating of the components 110 and 112. In at least one embodiment of the invention, such as is shown in FIG. 10, an additional force 118 may be applied to the welding region 116 during energy application to allow the layers 110, 112 and/or additional layers, such as 113, to be physically manipulated. By this method one or more of the layers 110, 112 and/or 113 may be stretched and/or made thinner.

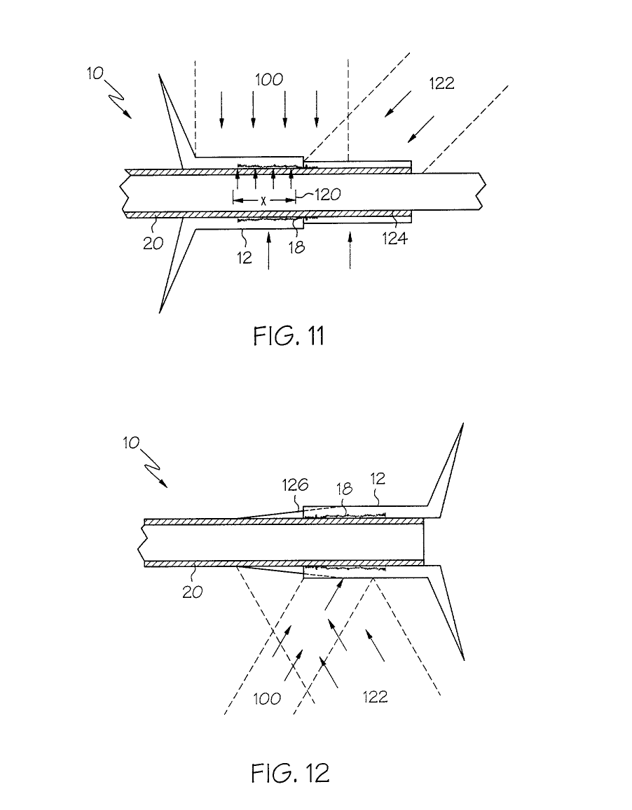

As indicated above, in some embodiments of the invention, multiple or different lasers or energy sources may be used to heat, melt or otherwise selectively manipulate material of a catheter. For example, in at least one embodiment of the invention, such as is shown in FIG. 11, a method for bonding a balloon end 12 to an outer layer 20 of catheter 10 is shown. In order to facilitate the bonding procedure, the balloon end 12 and/or the outer layer 20 is coated with, or at least partially includes therewith, an energy absorbent material 18, at the intended bond site 120.

In the embodiment shown, the balloon end 12 and outer layer 20 are characterized as being substantially non-absorbent of the wavelength of a first transmitted energy 100, whereas material 18 is selected to be at least partially absorbent of the wavelength of first transmitted energy 100. At least a portion of the balloon end 12 and/or outer layer 20 are characterized as being at least partially absorbent of a second wavelength of energy, such as is provided by a second transmitted energy 122.

In the present embodiment, first transmitted energy 100 is at least partially absorbed by material 18 thereby heating material 18. Material 18 is heated to a predetermined temperature or to a where the material 18 is sublimated and/or vaporized. Preferably, conductive heating of the surrounding material(s) 12 and/or 20 will form a bond between balloon end 12 and layer 20. However, in the present case it is not necessary for the first transmitted energy 100 and material 18 to interact to an extent sufficient to melt either the balloon end 12 or layer 20. In the present case the second transmitted energy 122 having a different wavelength is transmitted to the bond site 120, or a second layer or area 124 adjacent to the bond site.

In at least one embodiment, layer 124 is composed of a material that is different from balloon end 12 and/or layer 20. The second transmitted energy is at least partially absorbed by layer 124 to melt and thereby bond layer 24 to at least on of balloon end 12 or catheter layer 20. Absorption of the second transmitted energy 122 causes at least the area 124 to flow, preferably at a lower temperature than the bond site 120.

It should be noted that material 18 may be positioned underneath either balloon end 12 or layer 124, or under a portion of both end 12 and layer 124 as presently shown.

In at least one embodiment, energy 100 is laser energy such as may be transmitted from a diode type laser. In at least one embodiment, energy 122 is laser energy such as may be transmitted from a carbon dioxide type laser.

In at least one embodiment, the invention is directed to another method of using multiple energy sources to selectively manipulate catheter materials, such as is shown in FIG. 12. According to the present method a balloon end 12 may be bonded to the outer layer 20 and also provided with a tapered region 126. The bonded tapered region 126 is provided for by providing an inner layer 20, and/or an absorption layer 18 that is configured to absorb a first transmitted energy 100 and a balloon end 12 that is configured to absorb a second transmitted energy 122 but which is substantially transparent to the first transmitted energy 100.

In the present method the first transmitted energy 100 is transmitted through balloon end 12 to the outer layer 20 and/or layer 18 where it is at least partially absorbed, thereby causing the outer layer 20 to be heated. Preferably, balloon end 12 is configured to be substantially transparent to the first transmitted energy 100. The second transmitted energy 122 is transmitted directly to the balloon end 12 where it is at least partially absorbed thereby causing the balloon end 12 to be heated and flow. In at least one embodiment the first transmitted energy 100 and the second transmitted energy 122 are applied to the catheter 10 in sequence (i.e. one before the other). In at least one embodiment, the catheter 10 is exposed to both energies 100 and 122 at or around the same time. As balloon end 12 absorbs energy 122, the end 12 is heated. The end 12 begins to melt and eventually, the end 12 will disperse along layer 20 to form the tapered end 126 shown.

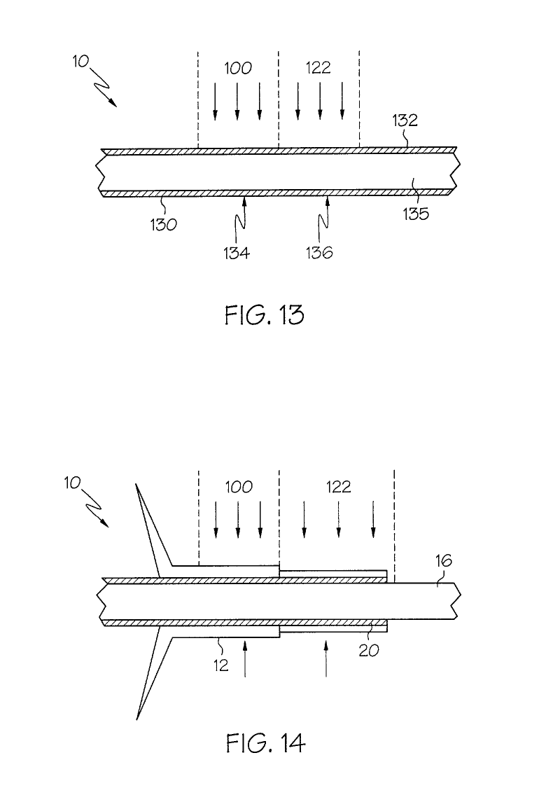

The methods for selectively manipulating catheter materials shown in FIGS. 11 and 12 and described immediately above, are preferably used to provide a “lap” style weld or bond between catheter components. In at least one embodiment of the invention however, multiple energies may be applied to a catheter to provide an end to end or “butt” weld. One such embodiment is depicted in FIG. 13.

In the embodiment shown, two tubular members 130 and 132 are disposed about a mandrel 135. As is shown in the drawings, an end 134 of the first member 130 and an end 136 of the second member 132 are positioned immediately adjacent to one another. In at least one embodiment, the members 130 and 132 are at least partially constructed from different materials. The first member 130 is configured to at least partially absorb first transmitted energy 100. The second member 132 is configured to at least partially absorb second transmitted energy 122. When the members 130 and 132 are exposed to the respective energies 100 and 122, at least the ends 134 and 136 maybe at least partially melted due to heat produced by energy absorption. As the ends 134 and 136 melt the members 130 and 132 will flow together thereby forming a single continuous catheter tube 10 when allowed to cool. Once the catheter 10 is formed the mandrel 135 may be removed.

In yet another embodiment of the invention, a balloon end 12 may be bonded to an inner shaft 16 of a catheter 10 and an outer layer 20 may also be bonded to the shaft 16 according to the method depicted in FIG. 14. In the embodiment shown the balloon end 12 is a different material than the shaft 16 and the outer layer 20 is also a different material than the shaft 16. The outer layer 20 and the balloon end 12 are also different materials from one another. In the present embodiment, the balloon end 12 is configured to at least partially absorb first transmitted energy 100 and the outer layer is configured to absorb a second transmitted energy 122. In order to secure two different materials, namely, outer layer 20 and balloon end 16 to the shaft 16, the first transmitted energy 100 is applied to the balloon end 12 to heat the balloon end material to or near its melting point. The second transmitted energy 122 will similarly heat the outer layer 20 to or near its melting point. Conduction of the heated outer layer 20 and/or balloon end 12 will cause the shaft 16 to be heated to a predetermined extent as well, preferably to its melting point. When the shaft 16 begins to melt, the material of the shaft 16 will flow together with one or both of the balloon end 12 and outer layer 20. When the catheter is allowed to cool the three different catheter components: balloon end 12, shaft 16, and outer layer 20 will be bonded together.

In an alternative embodiment of the invention, balloon end 12 is substantially transparent to first transmitted energy 100 and outer layer 20 is substantially transparent to second transmitted energy 122. The inner shaft 16 is constructed and arranged to at least partially absorb one or both of the first transmitted energy 100 and second transmitted energy 122. As the shaft 16 is heated to its melting point by one or both energies 100 and 122, conduction will heat balloon end 12 and/or outer layer 20, thereby bonding one or more of the components together as desired.

In addition to being directed to the specific combinations of features claimed below, the invention is also directed to embodiments having other combinations of the dependent features claimed below and other combinations of the features described above. The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

1. A method for manufacturing a medical device comprising:
providing a first component and a second component, positioning the first component and the second component adjacent to one another,
at least one of the first component and the second component having an energy absorption region, the energy absorption region constructed and arranged to at least partially absorb a first predetermined wavelength of energy,
at least one of the first component and the second component having a first energy transparent region, the first energy transparent region being substantially transparent to the first predetermined wavelength of energy;
transmitting the first predetermined wavelength of energy through the first energy transparent region; and
transmitting the first predetermined wavelength of energy to the energy absorption region, the energy absorption region substantially absorbing the first predetermined wavelength of energy, the energy absorption region being heated by substantially absorbing the first predetermined wavelength of energy.

2. The method of claim 1 further comprising the step of:
conductively transmitting heat from the energy absorption region to at least one adjacent portion of at least one of the first component, the second component and a third component.

3. The method of claim 2 further comprising the step of:
heating the at least one adjacent portion to at least its melting point.

4. The method of claim 2 wherein the at least one adjacent portion area is the first energy transparent region of at least one of the first component and the second component.

5. The method of claim 2 further comprising the step of:
heating the energy absorption region of at least one of the first component and the second component to at least its melting point.

6. The method of claim 3 further comprising the steps of:
removing the first predetermined wavelength of energy; and
cooling the energy absorption region and the at least one adjacent portion, thereby forming a bond between the energy absorption region and the at least one adjacent portion.

7. The method of claim 3 wherein the third component is adjacent to the energy absorption region of at least one of the first component and the second component.

8. The method of claim 3 wherein at least a portion of the third component is substantially transparent to the first predetermined wavelength of energy.

9. The method of claim 3 wherein at least a portion of the third component is constructed and arranged to at least partially absorb the first predetermined wavelength of energy.

10. The method of claim 3 wherein at least a portion of the third component is constructed and arranged to be at least partially reflective of the first predetermined wavelength of energy.

11. The method of claim 3 further comprising the steps of:
ablating or vaporizing the energy absorption region; and
cooling the first energy transparent region and the at least one adjacent portion of the third component thereby forming a bond between the energy transparent region and the at least one adjacent portion of the third component.

12. The method of claim 3 wherein the energy absorption region is radially disposed beneath the first energy transparent region.

13. The method of claim 3 wherein the energy absorption region is radially disposed beneath the at least one adjacent portion.

14. The method of claim 3 wherein the energy absorption region is longitudinally adjacent to the at least one adjacent portion.

15. The method of claim 3 wherein the first energy transparent region is constructed and arranged to at least partially absorb a second predetermined wavelength of energy.

16. The method of claim 15 wherein the at least one adjacent portion is constructed and arranged to at least partially absorb a second predetermined wavelength of energy.

17. The method of claim 16 further comprising the steps of:
transmitting the second predetermined wavelength of energy to the first energy transparent region, the first energy transparent region substantially absorbing the second predetermined wavelength of energy, the first energy transparent region being heated as a result of substantially absorbing the second predetermined wavelength of energy.

18. The method of claim 1 wherein the energy absorption region of at least one of the first component and the second component is a coating of energy absorbent material applied to the at least one of the first component and the second component.

19. The method of claim 18 wherein the coating is a colorant, the colorant being selected from at least one member of the group consisting of black colorants, red colorants, green colorants, white colorants, and any combination thereof.
